(19) United States
(12) Patent Application Publication
(10) Pub. No.: US 2008/0126149 A1
(43) Pub. Date: May 29, 2008

(54) Method to determine process input variables' values that optimally balance customer based probability of achieving quality and costs for multiple competing attributes

(76) Inventors: Artemis Kloess, Rochester Hills, MI (US); Robert V. Lust, Rochester, MI (US); R. Jean Ruth, Beverly Hills, MI (US); Sharon P. Zielinski, Macomb, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/501,514

(22) Filed: Aug. 9, 2006

(51) Int. Cl. G06Q 10/00

(52) U.S. Cl. 705/7

(57) ABSTRACT

A method for balancing competing attributes in a multi-attribute design optimization, which receives attributes and a set of input variables as inputs, and incorporates the variation of the input variables, is disclosed. The method receives transfer functions for the performance as a function of the input variables and for the customer assessment of the performance attributes. A preference function is constructed for each of a plurality of attributes to be balanced, the preference function defining a preferred outcome for a given set of inputs. The preference functions associated with each attribute are aggregated to define an aggregated preference function, thereby integrating the attributes. Optimal values are calculated for the set of input variables that optimize the aggregated preference function.

### BACKGROUND OF THE INVENTION

The present disclosure relates generally to business methods, and particularly to methods to determine the values for input variables to achieve a desired outcome.

Known methods to determine values for process input variables in search of desired optimized output attributes have been developed for component applications and require that multiple output attributes be decoupled from each other. That is, such methods require optimization of output attributes to be considered individually based upon the assumption that input variation to optimize one attribute does not affect the other attributes of interest. It is often the case that outputs compete with each other, meaning that they cannot be decoupled by the basic physical or conceptual design. They require some level of compromise, wherein a shift in the input variables to improve one attribute comes at the detriment of another attribute of interest. Further, known methods to determine process input variables often set a fixed target up front for each output attribute that is determined to be Critical To Quality (CTQ) and include tolerances around the target, which in effect, artificially and unrealistically decouples the attributes. As a result of the use of pre-set targets for multiple performance attribute problems, the output solution may not be optimally balanced and the probability of simultaneously meeting the targets for the multiple performance attributes may be very low.

Accordingly, there is a need in the art for a process variable optimization arrangement that overcomes these drawbacks.

### BRIEF DESCRIPTION OF THE INVENTION

An embodiment of the invention includes a method for balancing competing attributes in a multi-attribute design optimization, which receives attributes and a set of input variables as inputs and incorporates the variation of the input variables. An embodiment of the invention also receives transfer functions for the performance as a function of the input variables and for the customer assessment of the performance attributes. A preference function is constructed for each of a plurality of attributes to be balanced, the preference function defining a preferred outcome for a given set of inputs. The preference functions associated with each attribute are aggregated to define an aggregated preference function, thereby integrating the attributes. Optimal values are calculated for the set of input variables that optimize the aggregated preference function.

Another embodiment of the invention includes a program storage device readable by a machine, the device embodying a program or instructions executable by the machine to perform the aforementioned method.

### BRIEF DESCRIPTION OF THE DRAWINGS

Referring to the exemplary drawings wherein like elements are numbered alike in the accompanying Figures:

FIG. 1 depicts a process flow chart in accordance with an embodiment of the invention;

FIG. 2 depicts in graph form a customer transfer function in accordance with an embodiment of the invention;

FIG. 3 depicts in graph form an alternate form of customer transfer function in accordance with an embodiment of the invention;

FIG. 4 depicts in graph form a preference function in accordance with an embodiment of the invention;

FIG. 5 depicts in graph form an exemplary customer transfer function relating to wind noise in accordance with an embodiment of the invention;

FIG. 6 depicts in graph form an exemplary customer transfer function relating to door closure effort in accordance with an embodiment of the invention;

FIG. 7 depicts in graph form an exemplary customer transfer function relating to door panel appearance in accordance with an embodiment of the invention;

FIG. 8 depicts in chart form exemplary optimized design input variable values in accordance with an embodiment of the invention; and

FIG. 9 depicts in chart form exemplary probabilities of achieving quality for nominal and optimized design input variables in accordance with an embodiment of the invention.

### DETAILED DESCRIPTION OF THE INVENTION

An embodiment of the invention is referred to as Customer Driven Robust Integration and Optimization (CDRIO), which is an integrated approach to engineering design problems that require simultaneously balancing several attributes. CDRIO identifies the optimal distribution for each design input variable, taking into account transfer functions for the performance attributes, the variation in input variables, and customers' assessment of quality as a function of performance. A function of the distribution's parameters for each design input variable that might be used for controlling processes might be expressed as the nominal and standard deviation for a normal distribution, control limits for the values, a function of the mean and standard deviation, or lower and upper bound limits expressed as differences from the mean, or other functions of statistical moments, or other functions of the parameters. CDRIO searches for a design point that balances several performance attributes to find the best overall probability of achieving quality from the point of view of customers. Rather than rolling down individual fixed targets, a probabilistic framework and optimization based on aggregate preference functions are used to provide greater flexibility in design at the sub-system level.

CDRIO provides a balance between competing attributes in a multi-attribute design optimization approach that comprehends variation in the input variables. As used herein, the term ‘competing’ means measures that cannot be decoupled by the basic physical or conceptual design and that require trading-off performance attributes, such as vehicle performance attributes or business measures, for example. Further, CDRIO provides a framework for customer driven trade-offs for costs associated with performance, manufacturing tolerances, and design alternatives. CDRIO optimization uses design preference functions and an aggregation method that have desirable properties for engineering design. The outputs are optimal values for the design input variables, predicted performance, and predicted quality. The ultimate goal is to evaluate performance in terms of its corresponding probability of achieving quality from the customers' perspective. CDRIO can be run for multiple design alternatives. CDRIO can be rerun throughout the development cycle to compare optimal values to decisions current to a particular point of time.

The customer ‘loss function’ as used by CDRIO is a probability distribution. The optimization is not based on optimizing output attributes with respect to deviations from a fixed target value for each attribute, but rather simultaneously finds the best optimal distribution for each design input variable, considering the probability distribution for each, attribute, such as performance, customer quality, or other business attributes. CDRIO can preserve greater flexibility in order to identify the best engineering design solution, such as the focus on integration areas, such as subsystem and system level performance requirements, for example. The CDRIO framework also allows for cost/benefit trade-offs between performance, manufacturing, and design alternatives. With manufacturing and design alternatives' cost information and the relationship of a change in quality to purchase behavior or market share effect, the predicted quality can be converted to a predicted impact on cost and revenue.

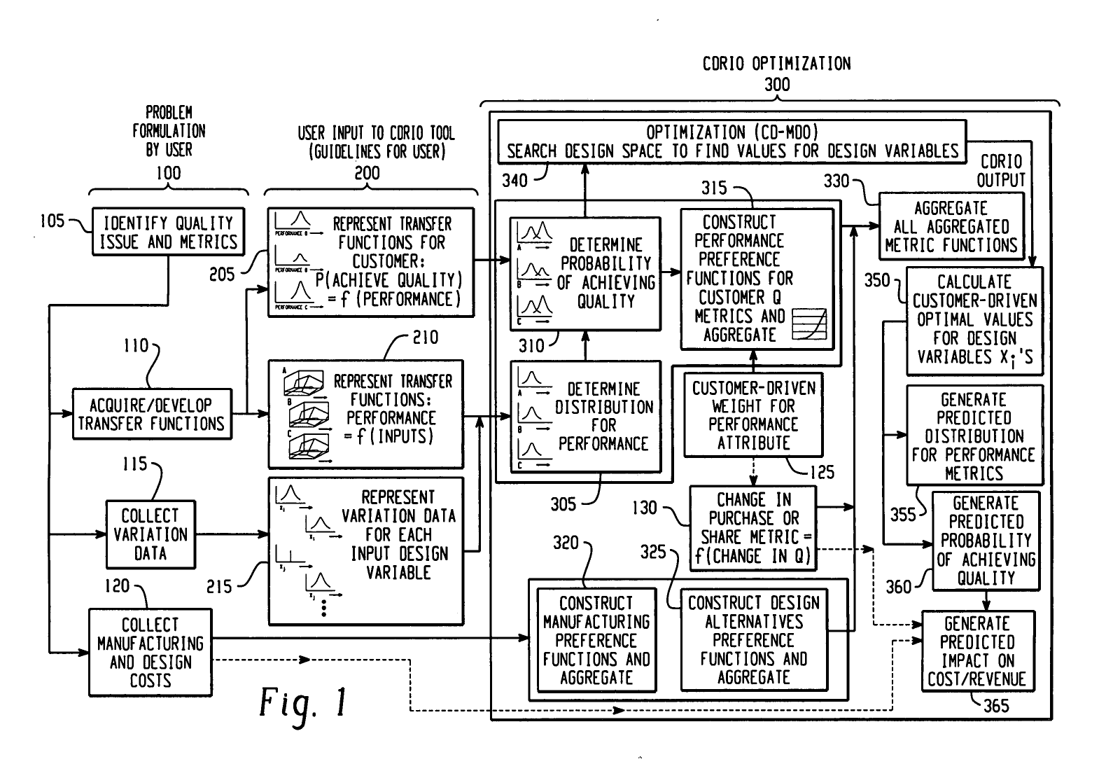

Referring now to FIG. 1, CDRIO can be seen to be broken into three main components: problem formulation 100; user input 200; and CDRIO optimization 300. The problem formulation 100 and user input 200 are performed by the user prior to CDRIO optimization 300.

In an embodiment involving problem formulation 100 for a quality issue, a user identifies 105 the customer-based quality metrics (also herein referred to as Customer-driven Q's). These metrics include data such as a set of performance attributes and corresponding performance metrics that are useful to achieving quality as assessed by customers (for example, “Critical-to-Quality” (CTQ's)), and the input design variables that need to be specified for a design (for example, dimensional xᵢ's, or any design specification for components, subsystems, or systems). There may be multiple quality metrics, and a performance attribute may have more than one metric.

Transfer functions will be acquired 110 for performance and for the customer-assessment of performance. Performance transfer functions may be estimated based on statistical results from a Design of Experiments or from a physics-based model. The customer transfer function captures customers' differences in their assessment of quality.

Collection 115 of variation data on the input variables, such as manufacturing variation around a nominal value and tolerances for an input design variable, is included in the formulation.

In an embodiment, manufacturing and design costs may optionally be collected 120 and provided to the optimization 300. If the change in cost for a particular or optimal solution is desired, the manufacturing and design costs could be used to evaluate such effects on cost.

In an embodiment where the attributes are to be functionally weighted differently based on customer importances or other customer-driven measures in the function being optimized, these weights are determined or user-provided at block 125. For example, impact-on-customer indices may be the impact on customer satisfaction, repurchase, overall quality perception, or recommendation as derived by a statistical model from data such as overall measures and responses to a problem, or performance questions from a survey, clinic data, or directly assessed importances. The optimization of quality can be done based on customer and performance transfer functions and the variation data.

Further, if the change in revenue for a particular or optimal solution is desired, the relationship between the change in purchase behavior or market share as a function of change in quality is determined or user-provided at block 130. If the change in revenue for a particular or optimal solution is desired, the relationship between the change in purchase behavior or market share as a function of quality will be used to evaluate such effect of any individual solution point. If the optimization 300 search is to incorporate cost and revenue in evaluating solutions (that is, values for the input design variables), the cost information and purchase behavior effects are collected at block 120, incorporated into preference functions at block 320 and 325, and along with block 130 incorporated into the overall aggregation block 330 and then are incorporated into the optimization 340.

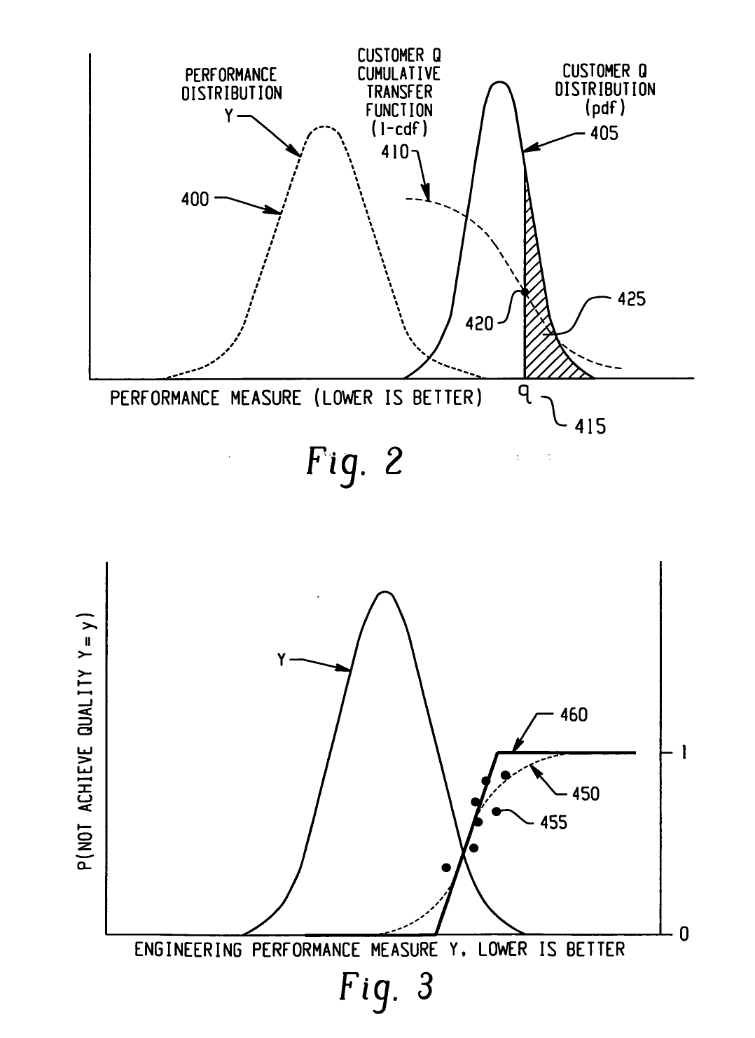

The user inputs information 200 on customers' assessment of performance, performance as a function of design, and performance variation. As used herein, the term “Customers” may be one or more of a variety of people, such as current and potential customers who buy or may buy a product and/or service, or internal or external people or groups who design the component, subsystem, or system in question. The next step is to develop 205 a customer transfer function. The customer transfer function represents the customers' assessment of performance. The customer transfer function provides a customer-assessed quality measure as a function of the value of each performance attribute. A probabilistic cumulative functional form for the customer transfer functions is used, specifically, the probability that the performance value equals or exceeds the value that is needed for the each performance attribute to ‘achieve quality’ as assessed by the customers. The customer transfer function is described in more detail below with reference to FIG. 2 and FIG. 3. FIG. 2 and FIG. 3, for the purpose of illustration, show one performance attribute. However, a customer transfer function could also be multidimensional, representing any interdependence of the values of two or more attributes on customers' assessment of the combined attributes.

For each performance attribute, the performance transfer functions are developed 210 to represent the performance as a function of the input design variables.

The collected 115 variation data, such as manufacturing variation data for example, are represented 215 as a function of the input design variables in the form of a univariate distribution for each input design variable or as a multivariate distribution for two or more input design variables. This could be in the form of a distribution around the nominal value for the engineering design, for example, for each input design variable.

Referring now to FIG. 2, the distributions (probability density functions) for a performance attribute Y 400 and for a customer quality metric Q 405 are depicted. For cases where lower values of the performance measure are better (such as vehicle-transmitted wind noise, for example), if Q=q is the highest value of the performance measure at which a customer still perceives that the performance level has achieved quality, then the value of the transfer function 410 at value q 415 (represented by reference numeral 420) is the hatched area 425 under the probability customer quality distribution 405 to the right of q 415. For the case where lower is better, a design that provides customer perceived quality has Y≦Q. For the case where higher is better, Q is the lowest value at which customer perceived quality is achieved, so a design that provides customer perceived quality has Y≧Q. To determine (310 in FIG. 1) a Probability of Achieving Quality, CDRIO evaluates a quality prediction for points in the design space: r=P(Y−Q≦0) for lower-is-better attributes; and, r=P(Y−Q≧0) for higher-is-better attributes. As used herein, the term “design space” refers to any set of potential values of the input design variables. The Probability of Achieving Quality might also be referred to as the ‘likelihood’ of meeting one or a set of such measures for quality. The customer driven metric for “Achieving Quality” may be determined in terms such as meeting customer requirements, meeting expectations, meeting needs, delighting the customer, satisfying the customer, and, for a motor vehicle, recommending the vehicle for example. These are all terms that have been used in survey and market research as measures of a customer's assessment, evaluation, and reaction. The metrics used could also be put in terms of not “Achieving Quality,” such as perceived problems per vehicle, as well as broader measures of the perception of the vehicle, as long as they can be interpreted in terms of a probability of achieving quality.

As an alternative to distribution 405, it may be more intuitive to think about Q in terms of a cumulative function 410 that relates to a fraction of customers who would determine that performance of “y or better” meets their standard for quality. In such a case, a function that corresponds to the cumulative Customer Q transfer function 410 may be used. The function corresponding to the cumulative Customer Q transfer function 410 is the probability of quality as a function of the performance measure or the “probability of achieving quality.” For the lower is better case, this cumulative function is in the form of the complement of the cumulative distribution function (cdf). For the transfer function for Q, this transfer function represents the conditional probability P (quality is achieved for a value of CTQ=q or better). Cases where lower is better over some range of values, and higher is better over the complementary range of values, can be handled by breaking the case into a lower-is-better case and a higher-is-better case. For convenience in applying the method, an embodiment of CDRIO can also handle a two-part case where over a range of values of the attribute higher-is-better and over a different range of values of the attribute lower-is-better by creating a single function that combines the corresponding cumulative functions into one transfer function. The cumulative function for achieving quality may also be expressed equivalently in terms of NOT achieving quality, that is, the probability of unacceptable or unsatisfactory performance, or (problems per 100 vehicles)/100. Referring now to FIG. 3, the dashed-line 450 represents the cumulative function form of the transfer function for such a complement of quality for the case when lower is better: 1−P(quality is achieved), for example, the probability that quality is not achieved.

This concept of ‘achieving quality’ and ‘not achieving quality’ can be used to represent problem counts as probabilities in cases where lower values of performance are better, higher values of performance are better, and a combination of these cases, using problem counts to construct cumulative distribution functions.

By using a probability distribution for Q for each CTQ, the flexibility to optimally balance competing performance measures in engineering design optimization can be retained, rather than starting with pre-set fixed targets for the attributes.

Often, the range of performance of interest and the data collected will be in a middle, almost linear, range of the cumulative distribution function, such as shown by the data points 455 in FIG. 3. In such cases, a linear placeholder customer function 460 (as in the solid piecewise linear distribution of FIG. 3) will be useful, as long as this is a good representation of the relationship between customer quality and performance, and the linear relationship covers the range of interest for the engineering design. Sensitivity analysis can help to determine if a ‘placeholder’ best-guess transfer function is appropriate, for example, if data are not yet available. If the data are from a non-linear portion of this range, such as may happen in a clinic where a more complete range or possible performance settings are evaluated, the linear placeholder may not be a good representation and a linear regression may be misleading, making the slope of the linear portion flatter or steeper than it should or would be with a non-linear function, such as the logistic, to fit the data. For example, original data respondent level data from a clinic could be used to best estimate such a function. For integration issues, which inherently means comparing and balancing attributes, scales (responses for the customer measures) for the different attributes from existing studies may be different, and different methods (such as a conversion procedure) may be done to convert each scale to the Probability of Achieving Quality.

Uncertainty about the exact form of the customer transfer function, or about other performance functions, costs, or parameters, can also be characterized and incorporated into CDRIO, using uncertainty methods such as Bayesian, possibilistic, evidence, or other approaches to handle uncertainty.

Referring now back to FIG. 1, CDRIO Optimization 300 comprises the steps for optimization for CDRIO, given the user inputs 200.

For each performance attribute, the performance transfer functions developed 210 are exercised with the variations represented 215 to determine 305 a probability distribution of obtaining a performance level for each attribute or a joint probability distribution of obtaining performance levels for multiple attributes based upon the performance transfer function developed 210 and variation data collected 115.

The determined 310 probability r that the performance will achieve customer-assessed quality (in terms of the metrics used for Customer Q) is determined from the determined 305 distributions for performance and the developed 205 customer distribution. This probability is herein referred to as “Probability of Achieving Quality”. The Probability of Achieving Quality is determined 310 for each performance attribute. The “Probability of Achieving Quality” can be calculated for any value in the design space, and so can be calculated as needed in the optimization.

The next step is to construct a preference function for each of a plurality of attributes to be balanced, the preference function defining a preferred outcome for a given set of inputs, followed by aggregating the preference functions for each attribute to define an aggregated preference function, thereby integrating the attributes. In an embodiment, using the determined 125 customer defined weights (that is, weights defined by a function rule), a customer quality performance preference function is constructed 315 for each performance attribute to be balanced. The performance preference functions related to each attribute are aggregated together to define an aggregated preference function, thereby integrating the attributes.

The approach of preference function and aggregation strategy proposed by Antonsson, Otto, Scott and Wood (Otto, K. N. and Antonsson, E. K., “Trade-off Strategies in Engineering Design,” Research in Engineering Design, Vol. 3, No. 2 (1999), 87-104; Scott, M. J. and Antonsson, E. K., “Aggregation Functions for Engineering Design Trade-Offs,” Fuzzy Sets and Systems, 99(3), 253-264, 1998; and, Wood, K. L. and Antonsson, E. K., “Computations with Imprecise Parameters in Engineering Design: Background and Theory,” ASME Journal of Mechanisms, Transmissions and Automation in Design, 111(4), 616-625, 1989) is adapted for CDRIO optimization 300. Erik K. Antonsson directed research (see above-noted references) in the development of formal methods for engineering decisions and trade-offs, and for representing and manipulating imprecision and preferences in engineering design. His students, William Law, Kevin Otto, Michael Scott, and Kristin Wood, contributed to the theoretical development and demonstration of the Method of Imprecision. The Method of Imprecision is a formal system for representing and manipulating imprecise design information through the specification of preferences on design and performance variables. The method uses aggregation functions to formally model different trade-off strategies. A class of aggregation functions, having properties desirable for engineering design, was presented in the literature (see above-noted references) for a continuum of trade-offs ranging from the compensating to the non-compensating. Other forms of preference function construction and aggregation methods could be used in CDRIO, including but not limited to utility-based estimates.

In an embodiment, different features of a vehicle, or different performance characteristics, will have different impacts on customers (viewed individually or as a group, such as a target market or segment). This difference in impact may be characterized by weights, or customer-based preference functions. For example, customer ratings (from survey questions, clinics, or internet studies, for example) on a set of items (such as features, performance, or problems) can be analyzed statistically to estimate the effect of each item on some overall measure (such as, the effect of a problem upon a customer's satisfaction, intent to repurchase, or likelihood of recommending the product). Estimates of effects (such as importance or utility) to a customer might be based on ratings in clinic studies or stated choices, as in conjoint studies, or revealed choices such as actual purchase behavior. Statistical methods could include descriptive methods or inferential methods (such as maximum likelihood estimates, various forms of regression, and/or Bayesian statistical methods). Such estimates may be used to construct a weight for an attribute relative to other attributes. An example of survey questions on vehicle attributes is the J. D. Power questions on “Things that you like and don't like” that J. D. Power uses to create a vehicle “APEAL” rating, such as may be found at http://www.jdpower.com/corporate/news/releases/index.asp, with keyword search of “2005 APEAL”. Weights could also be elicited from experts, as in the Quality Function Deployment and House of Quality approach [Hauser, John R. and Clausing, Don, “The House of Quality,” Harvard Business Review, May-June, (1988), 63-73].

Use of preference functions as developed for an engineering design allows aggregation in common units, exploration of an expanded design space, and the evaluation of the benefit of exceeding a reference probability R.

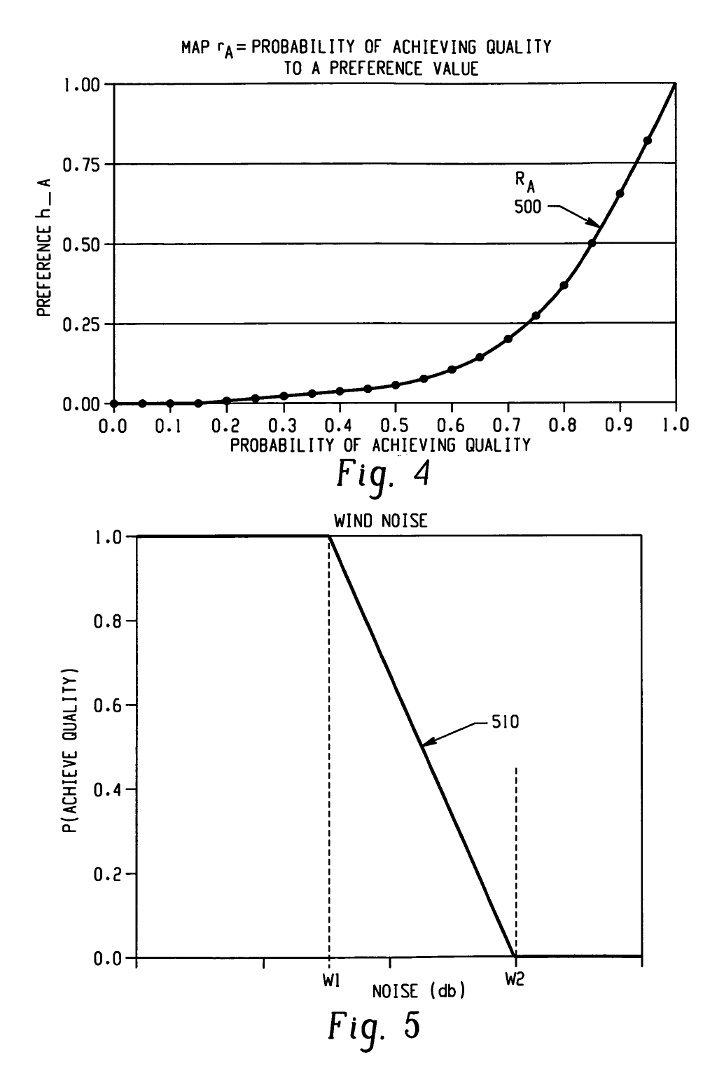

The aggregation strategy can expand the design search space and can provide a more complete Pareto frontier than a weighted-sum objective function. Referring now to FIG. 4, a preference function 500 for a performance attribute A is illustrated. Various forms or methods can be used in creating a preference function, which has a range from 0 to 1. One form for this preference function h(r), based on a preference of 0.5 for R and a preference of 1 for r=1, is given by:

$$h ( r ) = \frac{1}{1 + {3}^{( \frac{1 - r}{1 - R} )}} \qquad Equation \text{-} 1$$

where r is equal to the Probability of Achieving Quality, and R is equal to a reference probability.

The general form for an aggregate objective function with preference functions for two attributes, h₁ and h₂, and weights, w₁ and w₂, is:

$$h [ ( {h}_{1} , {w}_{1} ) , ( {h}_{2} , {w}_{2} ) ] = {( \frac{{w}_{1} {h}_{1}^{s} + {w}_{2} {h}_{2}^{s}}{{w}_{1} + {w}_{2}} )}^{1 / s} \qquad Equation \text{-} 2$$

While an embodiment of an aggregate objective function has been described with two attributes, it will be appreciated that the scope of the invention is not so limited, and that the invention also applies to other numbers of attributes, such as three, four, and more, for example.

As developed by Antonsson, Otto, and Wood, this aggregation approach satisfies the desirable properties of: (i) Idempotency: If several variables with equal preference are combined, the overall preference must be the same; (ii) Monotonicity: The overall preference cannot decrease as a result of an increase in preference for one attribute; (iii) Commutativity: the aggregation operator is orderless, in that the aggregation does not depend on the order in which the preference functions are aggregated; and, (iv) Continuity: a function f(x) is continuous at x=c if we can find a δ>0 such that for a<c−δ and c<b<c+δ the range of values of f(x) on the interval (a, b) is (f(a), f(b)). The selection of s in Equation-2 determines whether the additional annihilation property is satisfied, that is, if the preference for any one attribute of the design is zero, then the overall preference for the design is zero. The value of s also can be interpreted as the degree of willingness to tradeoff one attribute for another. The higher the value of s, the greater the tradeoff willingness. If s<0, annihilation is satisfied, and a higher preference in one attribute cannot completely compensate for lower preference in another. In the limit, as s decreases, the overall objective approaches the minimum function of the individual preferences. If s=1, the objective function becomes a simple weighted sum, which does not have the desirable annihilation property. An aggregation strategy of s=−1 identifies a more complete Pareto frontier than a weighted sum objective. CDRIO uses weights for the performance attributes, such as weights based on consumer assessments, customer preferences, or customer desires.

A manufacturing preference function for each attribute may be constructed 320 and aggregated. Similarly, a design alternatives preference function for each attribute may be constructed 325 and aggregated. Construction 320, 325 and aggregation of such preference functions allow such preferences to be incorporated into the optimization 300.

Each of the constructed 315, 320, 325 and aggregated functions are aggregated together 330, to define a grand aggregated preference function.

In an embodiment of CDRIO, multiple performance attributes are balanced, considering the trade-offs and the Pareto frontier for competing attributes. The reference R can be mapped to a point that is of particular interest around which to expand the search, such as the Probability of Achieving Quality or likelihood of achieving customer-perceived quality corresponding to a current or proposed nominal design. Given the transfer functions for customer-driven quality as a function of performance, in addition to transfer functions for performance as a function of the design input variables (such as a response surface for performance as a function of dimensional settings), a search for the optimal distribution for each design input variable, that will optimally balance the competing performance attributes from the point of view of customers can be made. Embodiment-1 summarizes one embodiment of the performance preference function and aggregation strategy utilized in an exemplary CDRIO application.

Objective = (λₚhₚ^{s} + λₘhₘ^{s} + λ_{d}h_{d}^{s})^{1/s}
Aggregation strategy s = −1.
Subscript p denotes performance preference
function, m is manufacturing, and d is design.
Preference Function for Performance
hₚ = (w_{A}h_{A}^{s} + w_{B}h_{B}^{s} + w_{C}h_{C}^{s} + w_{D}h_{D}^{s})^{1/s}
where A, B, C, D denote performance attributes and
w_{A}, w_{B}, w_{C}, w_{D} are based on impact-on-
customer indices.
Preference function expressions could be
constructed for manufacturing and design
alternatives.

### Exemplary Embodiment

In an embodiment, a point in the optimization design space is a set of values for the input design variables. CDRIO global optimization 340 uses an overall weighted aggregation based on performance that may also be based on manufacturing and design alternatives. As discussed with respect to Steps 315, 320, and 325, the use of preferences allows aggregation in common units, exploration of an expanded design space, and the evaluation of benefit of exceeding a reference probability R of achieving quality. For any point in the design space for a design alternative, CDRIO evaluates how well multiple performance measures simultaneously meet the overall weighted preference function values for the achievement of customer perceived quality. The CDRIO optimization 340 searches the points of the design space and evaluates each selected candidate point in turn to find the best solution. The calculation of the probability or likelihood of achievement of customer perceived quality may be done for smaller problems by Monte Carlo simulation. For problems of a size or complexity that are computationally intensive, special tools like fast probability integration may be used. Additionally, an optimization method can be selected from the suite of MATLAB™ optimization tools. The TOMLAB™ solver glbSolve™ implements the global optimization algorithm DIRECT™, developed by D. Jones [D. R. Jones, “The DIRECT Global Optimization Algorithm”, Encyclopedia of Optimization, Kluwer Academic Publishers, 2001].

The optimization 340 calculates 350 values of the design input variables for this point, the optimal distribution for each design input variable, such as both the nominal and the standard deviation, to optimize the grand aggregated preference function. The optimization 340 calculates 350 the values of the design input variables in the absence of given targets for the output attributes. Additionally, the optimization 340 generates 355 a predicted distribution for each performance attribute, and generates 360 a predicted probability of achieving quality from the customer perspective based upon the calculation 350 of these optimal input variable values (or for any candidate solution in the design space). Further, if at least one of the manufacturing and design costs have been collected 120, and the customer-driven weight for performance determined 125 as well as the change in purchase behavior or market share as a function of achieving quality from the customer perspective is determined 130, then a predicted impact on cost and/or revenue is generated 365 based upon the calculation 350 of the optimal values.

An advantageous feature of CDRIO is how Customer Q is represented and how the optimization is accomplished. CDRIO makes use of a probability distribution for customer-perceived quality as a function of the value of the performance attribute and the variation in the performance. By including manufacturing variation of the input design variables, the design optimization can use preference functions for each performance attribute, for manufacturing tolerances, for the customer-perceived quality, and/or additional business attributes to balance the output attributes and determine the optimal mean and tolerance for each of a set of attributes.

The inclusion of the effects on product performance from manufacturing capabilities (production variation) and customer differences provides a solution that is more robust in terms of customer quality as well as performance variation. Further, the inclusion of manufacturing and design costs, (and uncertainty about these costs), can provide a framework for balancing customer driven trade-offs with costs associated with performance, manufacturing tolerances, and design alternatives.

CDRIO optimization can use any Multidisciplinary Design Optimization (MDO) approach. However, based on the desirable engineering design properties, the preference function and aggregation strategy approach of Antonsson, Otto, and Wood has been adapted for use with CDRIO. As best known to the inventors, this approach has not previously been incorporated into a method that includes probability-based customer transfer functions and production variation.

As applied to CDRIO, the preferred aggregation strategy can identify a more complete Pareto frontier than a simple weighted sum objective function and does not completely compensate for a lower preference in one attribute with a higher preference in another attribute, for example, a failure in one performance attribute cannot be compensated for by higher performance in others.

An Illustrative Example of CDRIO follows:

An embodiment of CDRIO was used to optimally balance competing performance measures of wind noise, closing effort, and appearance for a vehicle door system. Door assembly and vehicle usage variation were used with previously developed hardware-based transfer functions to determine distributions for each performance measure. Variation in the customers' assessment of door system quality was input as cumulative distribution functions. In a probabilistic framework, CDRIO identified a design solution that optimized an aggregate preference for door system quality.

Other examples can be based on other systems, and additional performance or business attributes employed, such as: the sound of door closing for a door system; fuel economy, mass, and acceleration for vehicle systems; and, revenue and cost for business subsystems, for example.

A problem to best determine values for the design variables begins with identifying the quality issue, the customer driven quality metrics and the performance metrics, and acquiring/developing the transfer functions. In this illustrative example, we use a door system for analysis and establishing the objective to improve the metrics in the areas of wind noise, door closing effort, and appearance fits. As will be discussed further below, performance transfer functions can be developed for a system based on design of experiments with hardware or physics based models, statistical analyses, or other means.

### Customer Transfer Functions

Available sources of customer information for wind noise, closing effort, and appearance fits were converted into a probability of achieving quality vs. performance value. The following sections summarize the resulting placeholder customer transfer function for each performance attribute, as in block 205. These customer transfer functions may be updated as additional information is made available.

### Wind Noise

The first step in the development of a customer transfer function for wind noise is to identify candidate customer and performance measures. A customer measure could be survey or clinic based, such as problem counts from a syndicated survey such as J. D. Power. In this example, the main performance measure is vehicle-level wind noise.

The above noted performance measure was converted into door system wind noise (decibels dB), where near 100% of customers would perceive problems for values greater than W2 and almost none for door system wind noise values less than W1. For example, a piecewise linear transfer function based on a customer-based and/or benchmark-based specification can be used: P(achieve quality at W1)=1 and P(achieve quality at W2)=0 with a straight line 510 between these two values, as illustrated in FIG. 5.

### Closing Effort

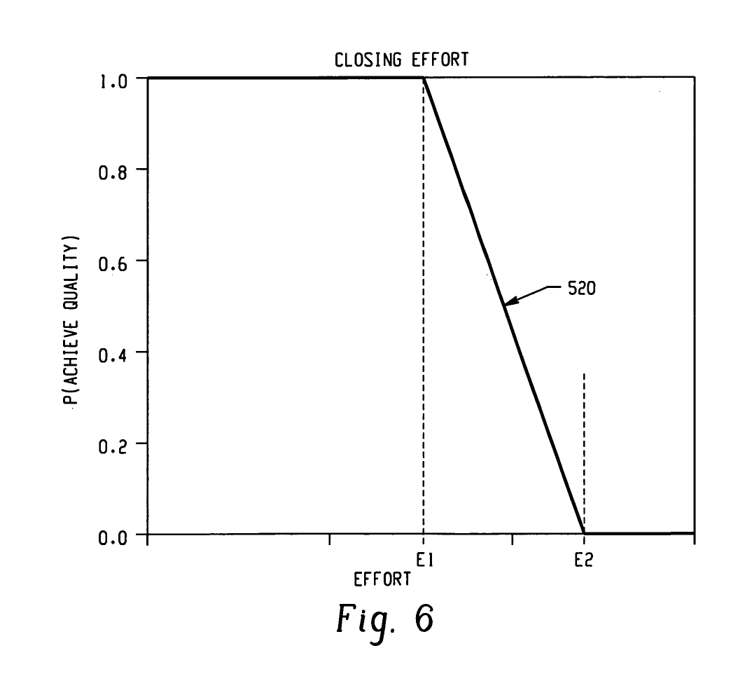

Results from door closing effort clinics can be used to construct the closing effort customer transfer function 520 piecewise linear example shown in FIG. 6.

The above noted transfer function was converted to a closing effort measure (such as velocity or energy for example), where near 100% of customers would perceive problems for closing effort values greater than E2 and none for closing effort values less than E1. For example, a piecewise linear transfer function based on a specification can be used: P(achieve quality at E1)=1 and P(achieve quality at E2)=0 with a straight line 520 between these two values, as illustrated in FIG. 6. The values for E1 and E2 for the vehicle were determined based on several clinic studies with participants evaluating opening and closing vehicle doors.

### Appearance

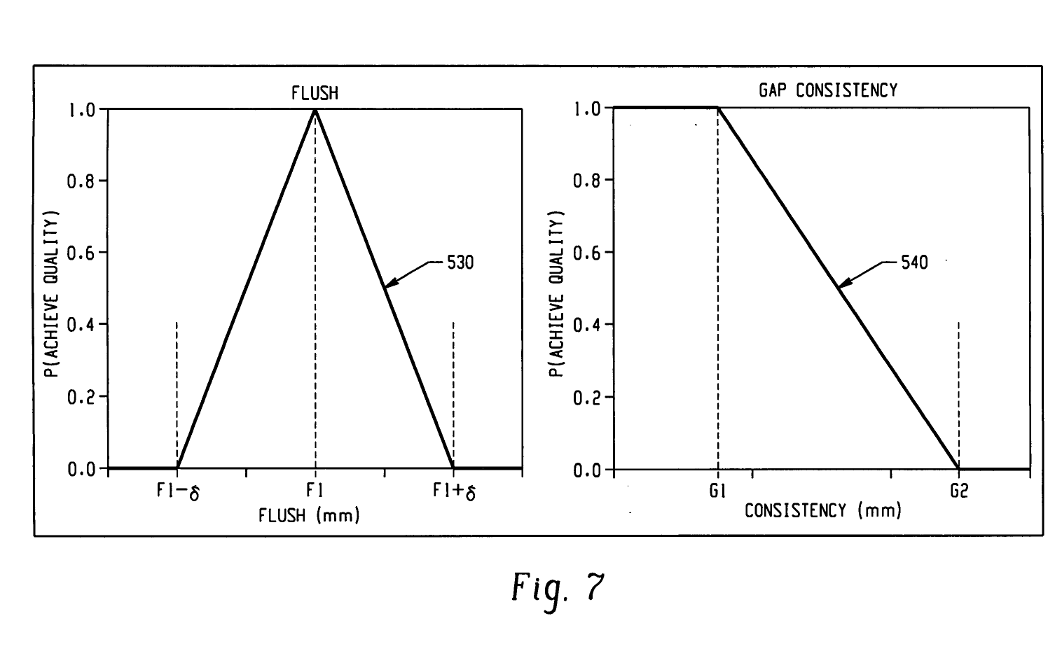

Appearance, or fit of the door relative to the body, can be represented by multiple measures. In this illustrative example appearance is represented by flush and gap. Appearance by flush is defined as the separation between the door and any contiguous panel in the vehicle body in the direction perpendicular to the plane of the panel. Appearance by gap is defined as the separation between the door and any contiguous panel in the vehicle body in the direction parallel to the plane of the panel. Consistency is whether the gaps at different locations are the same size. Customer information regarding appearance was based on a fit study for the door system. FIG. 7 is based on clinic results for flush 530 and gap consistency 540 applicable to the door compared to the placeholder customer transfer function used for the door system.

The clinic data for flush suggests F1 being best, where here F1represents an acceptable “flush” condition. A non-symmetric transfer function could be used; however for simplicity in this door system example, a symmetric customer transfer function about F1 mm (millimeters) was assumed, which combines two cumulative functions. One function is P(achieve quality at F1 mm)=1 and P(achieve quality at F1+δ)=0, with a straight line between these two values. The other function is defined by P(achieve quality at F1 mm)=1 and P(achieve quality at F1−δ)=0, with a straight line between these two values. Here, δ represents an incremental difference in gap dimension.

For appearance by gap consistency, the P(achieve quality) measure for the clinic seems to reflect a more complete logistic-like transfer function, and not just the linear mid-range. As shown, a linear placeholder (represented by line 540) between G1 and G2 is used based on the mid-range section of the data which covers the vehicle design range of interest.

### Performance Transfer Functions

Transfer functions for the performance measures of wind noise, door closing effort, and appearance were developed through a carefully planned hardware Design of Experiments (DOE). Door system vehicle performance models were developed using hinge and striker locations, heretofore designated as DV1, DV2, through DV8, seal design (Design 1,2,3), door crown, wind speed, and wind direction. Door system vehicle performance models were determined from measurements of door system wind noise, door closing effort, and appearance flush and gap at selected door locations. It should be noted that transfer functions developed from physics-based CAE (Computer Aided Engineering) models of the door-to-body system are easily incorporated into CDRIO.

### Variation Data

Input to the performance transfer functions in the stochastic analysis portion of CDRIO (Probability of Achieving Quality in FIG. 1) consists of control variables, which include random design variables (hinge and striker locations of the door and categorical variables (seal design and crown), and noise variables (wind speed and direction). The variance of the controllable factors is inherent to the process and was obtained based on historical data. Variation for noise variables in the stochastic analysis utilized statistical distributions for wind speed and wind direction. Actual customer usage data could also be used.

### Optimization

An objective is to optimally design the system while managing cost/benefit trade-offs between performance measures, manufacturing tolerances, and design alternatives. In this door system example, only trade-offs between competing performance measures were considered.

In the context of design reliability, the Probability of Achieving Quality, r, is defined as the probability that the design's performance level meet or exceed customer requirements. Different probabilistic approaches can be used to estimate product performance reliability. Some methods use approximate analytic techniques to alleviate the computational burden when using response models that are implicit functions of the random variables. Other direct simulation techniques require more response calculations for accuracy, but are applicable when, as in this case, simple equations are used for response models.

Preference functions provide a common characterization for uncommon metrics and also expand the search space for Probability of Achieving Quality, e.g., maximizing the likelihood of meeting customer requirements. Preference function values range from 0 to 1, where 0 is least preferred and 1 is most preferred. The preference function, h(r), is defined above as Equation-1, where r is the predicted probability of achieving quality, and R is a reference value for the Probability of Achieving Quality. Reference values are assigned by the user and represent either the current quality level or an anticipated quality improvement. Equation-1 defines the preference function such that when r=0 (or zero Probability of Achieving Quality), the preference value is 0, when r=1, the preference value is at its most preferred value of 1, and at the reference value R, the preference function, h(r), equals 0.5.

Preference aggregation is a formal method to explicitly perform trade-offs between multiple performance measures and conflicting criteria. The individual preference functions, h_{wn}, h_{ce}, h_{f}, h_{g}, are aggregated into an overall preference function h^{s} given by:

$${h}^{s} = {( \frac{{w}_{wn} {h}_{wn}^{s} + {w}_{ce} {h}_{ce}^{s} + {w}_{fl} {h}_{fl}^{s} + {w}_{gp} {h}_{gp}^{s}}{{w}_{wn} + {w}_{ce} + {w}_{fl} + {w}_{gp}} )}^{1 / s} \qquad Equation \text{-} 3$$

where s is a real number. This aggregation satisfies desirable properties of idempotency, monotonicity, commutativity, and continuity. For s<0, the aggregation operator h^{s} also satisfies the annihilation property which states that if the preference for any one attribute becomes unacceptable, then the overall preference is unacceptable or zero. The parameter s can be interpreted as the level of compensation or trade-off, and is sometimes referred to as the trade-off strategy. Higher values of s indicate a greater willingness to allow preference for one criterion, to compensate for lower values of another criterion. As s→∞, the aggregation provides no compensation and the overall preference tends to the minimum of the individual preferences. If annihilation is not imposed and s=1, h^{s} becomes the often used weighted sum operator. In the door system example disclosed herein, s=−1.

Customer Satisfaction/Dissatisfaction Indices measure the impact of a problem noticed and are used for the importance weights, w_{wn}, w_{ce}, W_{fl}, w_{gp}, in the preference aggregation of Equation-3. Obtained from statistical models analyzing customer survey data, the indices are the change in satisfaction at three years of ownership. Estimated by the type of problem (from survey data) for each vehicle segment, the index is an estimate of the impact on customers of reliability and durability by problem category. Coupled with a trade-off strategy of s=−1, the multi-attribute optimization of CDRIO focuses on door system performance attributes that matter most to the customer without allowing any of them to be traded to zero.

A global optimization program, such as DIRECT™ (DIvisions of RECTangles), performs the optimization. Input to the optimization program includes a characterization of the distribution of each input design variable, such as means and standard deviations or other parameters which characterize the distributions.

### Output

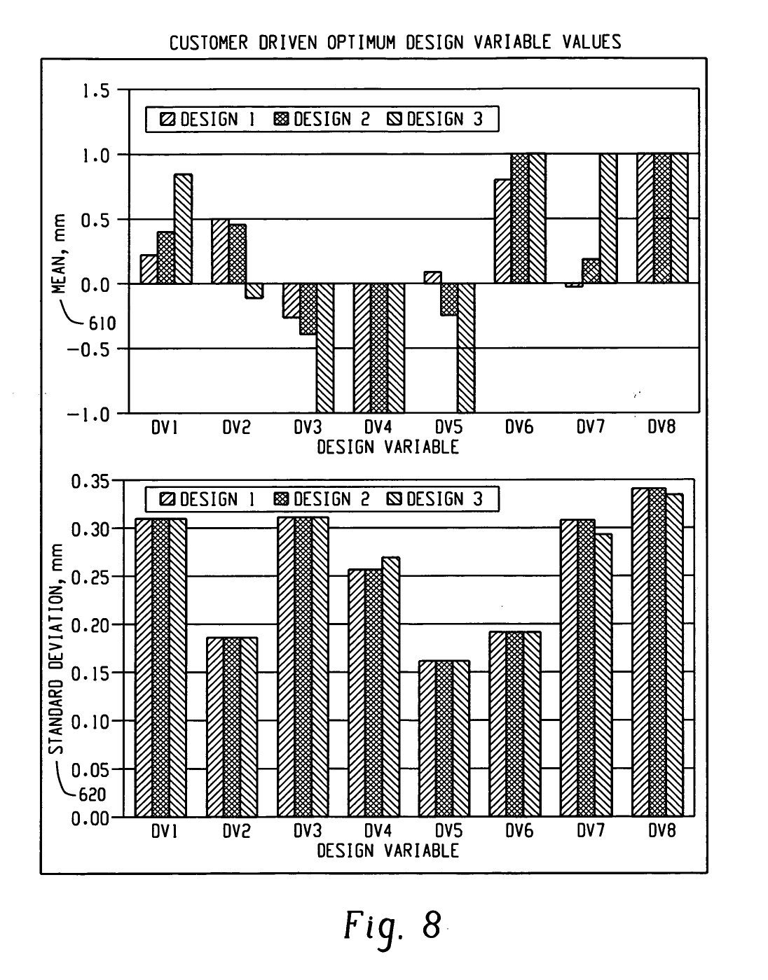

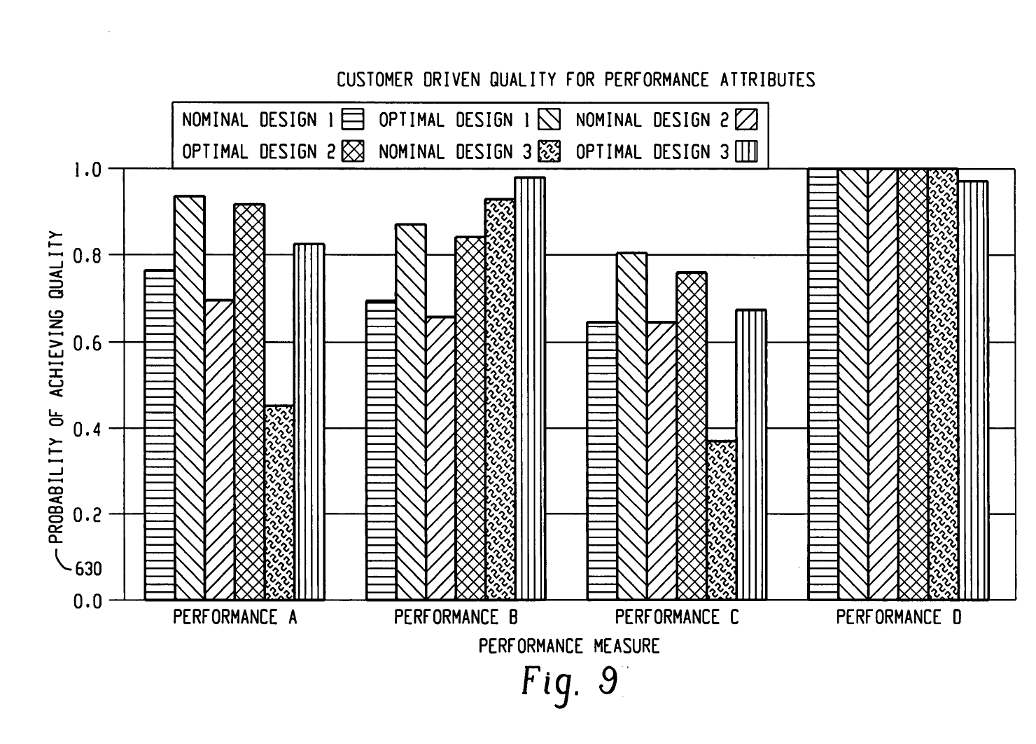

CDRIO results for the door system example are shown in FIGS. 8 and 9. FIG. 8 displays the optimum mean 610 and standard deviation 620 values for hinge and striker locations (relative to nominal) for the three seal designs and no crown. The results show that the optimal positions for the hinge and striker locations differ for each seal design. FIG. 9 illustrates the improvement in the resulting Probability of Achieving Quality 630 compared to the nominal case. Based on the customer driven optimization, the Probability of Achieving Quality improved for all performance measures, simultaneously, and this solution is robust for the distribution of wind speed and angle considered.

A user interface to the execution of CDRIO enables the input of variation in design variables and differences in customer preferences to predict the probability of meeting customer requirements for wind noise, closing effort, flush, and gap. It also enables the input of customer driven trade-off weights to determine the optimal balance of these competing performance measures. The interface provides data input flexibility by using files to transfer data between the interface tool and programs. In addition to displaying output to a screen, results may be stored in files that, can be used with other post-processing tools. A quick assessment of a given design's ability to meet customer requirements can be performed either before or after the optimization process. Also, the interface tool can be used to create Pareto frontier curves for various trade-off scenarios and then compared to the customer driven solution that CDRIO identifies.

CDRIO provides a state-of-the-art integrated approach that goes beyond Design for Six Sigma by integrating advanced methods of reliability analysis, robust design, the translation of customer requirements, and multi-criteria optimization. Using the door system as an example illustrates the input of customer and performance transfer functions for CDRIO to determine a design solution that simultaneously optimizes customer preferences towards wind noise, closing effort, and appearance fits and is robust to wind speed and wind angle. Optimal mean and standard deviation values for the hinge and striker locations, and the associated optimal Probability of Achieving Quality, were obtained for three seal designs. CDRIO can also generate the Pareto frontier solutions; however, by using the customer indices as importance weights in the aggregation scheme, CDRIO identifies a customer driven optimal solution.

An embodiment of the invention may be embodied in the form of computer-implemented processes and apparatuses for practicing those processes. The present invention may also be embodied in the form of a computer program product having computer program code containing instructions embodied in tangible media, such as floppy diskettes, CD-ROMs, hard drives, USB (universal serial bus) drives, or any other computer readable storage medium, wherein, when the computer program code is loaded into and executed by a computer, the computer becomes an apparatus for practicing the invention. The present invention may also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing the invention. When implemented on a general-purpose microprocessor, the computer program code segments configure the microprocessor to create specific logic circuits. A technical effect of the executable instructions is to optimize process input variables to achieve a desirable combination of inter-related process output attributes.

As disclosed, some embodiments of the invention may include some of the following advantages: the ability to determine the optimal distribution for each input variable to provide desired output attributes while considering the inter-relationships of the attributes; the ability to best balance performance and other business attributes by including manufacturing variation of the input design variables; the ability to produce a solution that is more robust in terms of customer quality as well as performance variation by including product performance that reflects manufacturing capabilities; the ability to provide a more complete Pareto frontier than a simple weighted sum objective function; and the ability to ensure that a higher preference in one attribute cannot completely compensate for a lower preference in another.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention-therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

1. A method for balancing competing attributes in a multi-attribute design optimization, which receives attributes and a set of input variables as inputs, the method comprising:
constructing a preference function for each of a plurality of attributes to be balanced, the preference function defining a preferred outcome for a given set of inputs; aggregating the preference functions associated with each attribute to define an aggregated preference function, thereby integrating the attributes; and
calculating optimal values for the set of input variables that optiize the aggregated preference function.

2. The method of claim 1, which receives as inputs a performance transfer function and variation data and a customer transfer function, the method further comprising:
determining a probability distribution of obtaining a performance level for each attribute based upon the performance transfer function and variation data; and
representing the customer transfer function as a probability distribution of achieving customer quality based upon performance attribute values.

3. The method of claim 2, further comprising:
determining a probability that customer determined quality will be achieved based upon each of the performance level probability distributions and the customer-driven transfer function.

4. The method of claim 1, wherein the constructing a preference function comprises at least one of:
constructing a customer quality performance preference function for each attribute; constructing a manufacturing preference function for each attribute; and
constructing a design alternatives preference function for each attribute.

5. The method of claim 4, wherein:
the constructing a preference function comprises at least two of:
constructing a customer quality performance preference function for each attribute;
constructing a manufacturing preference function for each attribute; and
constructing a design alternatives preference function for each attribute;
the method further comprises aggregating the aggregated preference functions to define a grand aggregated preference function; and
the calculating comprises calculating a set of input variables that optimize the grand aggregated preference function.

6. The method of claim 1, further comprising:
generating a predicted distribution for performance based upon the calculated input variables.

7. The method of claim 1, further comprising:
generating a predicted probability for achieving customer determined quality based upon the calculated input variables.

8. The method of claim 1, further comprising:
generating a predicted impact on cost and revenue based upon the calculated input variables.

9. The method of claim 1, wherein:
the constructing a preference function comprises constructing a preference function h(r) of the form:
$$h ( r ) = \frac{2}{1 + {e}^{( i n 3 ) ( \frac{1 - r}{1 - R} )}}$$
where:
r is equal to the Probability of Achieving Quality; and
R is equal to a reference probability.

10. The method of claim 1, wherein:
the aggregating the preference functions for each attribute comprises aggregating the preference functions for two performance attributes h[(h₁,w₁),(h₂,w₂)] according to the form:
$$h [ ( {h}_{1} , {w}_{1} ) , ( {h}_{2} , {w}_{2} ) ] = {( \frac{{w}_{1} {h}_{1}^{s} + {w}_{2} {h}_{2}^{s}}{{w}_{1} + {w}_{2}} )}^{1 / s}$$
where:
h₁ is equal to a first attribute
w₁ is equal to a weight for the first attribute
h₂ is equal to a second attribute; and
w₂ is equal to a weight for the second attribute.

11. The method of claim 1, wherein:
the calculating occurs in the absence of given targets for output attributes.

12. The method of claim 1, wherein:
the calculating comprises a global optimization technique based on the aggregated preference function.

13. The method of claim 17 wherein:
the constructing a preference function comprises determining a customer-driven weight for each attribute.

14. The method of claim 8 wherein:
the generating a predicted impact on cost and revenue comprises determining a change in purchase behavior function, dependent upon determining a customer-driven weight for each attribute.

15. The method of claim 1, wherein:
the calculating optimal values for a set of input variables further comprises calculating optimal values for a set of input variables that include distribution-characterizing parameters that optimize the aggregated preference function.

16. The method of claim 15, wherein:
the distribution-characterizing parameters include both nominal and standard deviation values for the set of input variables.

17. A prog storage device readable by a machine, the device embodying a program or instructions executable by the machine to perform the method of claim 1.
